(19) United States
(12) Patent Application Publication
(10) Pub. No.: US 2008/0228926 A1
(43) Pub. Date: Sep. 18, 2008

(54) Methods, media, and systems for balancing session initiation protocol server load

(76) Inventors: Asher Shiratzky, Tel Aviv (IL); Danny Loeb, Haifa (IL); Yossi Gabai, Ra'anana (IL); Stephen Dieugenio, Hewitt, NJ (US)

Correspondence Address: Byrne Poh LLP, 11 Broadway, Ste 865, New York, NY, 10004, US

(21) Appl. No.: 11/717,365

(22) Filed: Mar. 13, 2007

(51) Int. Cl. G06F 15/16

(52) U.S. Cl. 709/228

(57) ABSTRACT

In some embodiments, methods for balancing SIP server load are provided. In these methods, a message is received and a session identifier and a resource identifier are extracted from the message. The methods search for one or more sessions associated with the resource identifier and, if there is at least one session that is associated with the resource identifier, the methods further determine whether one of the at least one session is associated with the session identifier. If one of the at least one session is determined to be associated with the session identifier, the methods obtain a server identifier associated with the one of the at least one session and forward the message to a server associated with the server identifier.

### TECHNICAL FIELD

The disclosed subject matter relates to methods, media, and systems for balancing session initiation protocol server load.

### BACKGROUND

The Session Initiation Protocol (SIP) is a text-encoded, highly extensible signaling protocol for initiating, managing, and terminating interactive voice and video sessions across packet networks for real-time data communications. Basic SIP services are services for which a SIP server acts as a stateless or stateful proxy or a registrar that helps establish initial handshaking between two SIP clients. The signaling and media controls for the basic services are directly performed by transacting the two SIP clients (e.g., caller and callee) after the initial handshakes.

The SIP can be extended to accommodate advanced services, such as multi-party voice or video conferencing, messaging, presence, etc., on top of the basic SIP services. In order to provide advanced services, servers may need to operate in a session mode, under which multiple sessions are linked together by sharing a common resource that is handled by one server. A server providing advanced services, for instance, may receive user calls and initiate and handle separate sessions with a destination. Therefore, the signaling for such calls must pass through the specific server for the lifetime of the call session.

In order to balance loads on servers in communications networks, load balancers are frequently utilized. A problem with current load balancing solutions is that they work under the assumption that any server can be used for any call when, for example, a particular server should be used for providing advanced services. Therefore, the current load balancing solutions are insufficient for SIP advanced services.

In order to provide high availability of services, backup servers in SIP networks are currently made available through a hot-stand-by model in which the backup server stands by only to be used in case of a failure of another server. While this solution can achieve the goal of having a substitute server available, it is expensive to purchase and maintain servers that are only used in backup scenarios.

### SUMMARY

Methods, media, and systems for balancing session initiation protocol server load are provided. In some embodiments, methods for balancing service load are provided. These methods receive a message, extract a session identifier and a resource identifier from the message, search for one or more sessions that are associated with the resource identifier, and if there is at least one session that is associated with the resource identifier, determine whether one of the at least one session is associated with the session identifier. If one of the at least one session is determined to be associated with the session identifier, the methods obtain a server identifier associated with the one of the at least one session and forward the message to a server associated with the server identifier.

In some embodiments, computer-readable media containing computer-executable instructions that, when executed by a processor, cause the processor to perform a method for balancing SIP server load, are provided. The method includes: receiving a SIP message; extracting a session identifier and a resource identifier from the message; searching for one or more sessions that are associated with the resource identifier; and if there is at least one session that is associated with the resource identifier, determining whether one of the at least one session is associated with the session identifier; and if one of the at least one session is determined to be associated with the session identifier, obtaining a server identifier associated with the one of the at least one session; and forwarding the message to a server associated with the server identifier.

In some embodiments, devices for balancing SIP server load include an interface for receiving a SIP message; and a processor that: extracts a session identifier and a resource identifier from the message; searches for one or more sessions that are associated with the resource identifier; and if there is at least one session that is associated with the resource identifier, determines whether one of the at least one session is associated with the session identifier; and if one of the at least one session is determined to be associated with the session identifier, obtains a server identifier associated with the one of the at least one session; and forwards the message to a server associated with the server identifier.

### BRIEF DESCRIPTION OF THE DRAWINGS

FIG. 1 is a schematic diagram of a communication network containing elements for balancing server loads in accordance with some embodiments of the disclosed subject matter.

FIG. 2 is a simple illustration of a method for balancing server loads in accordance with some embodiments of the disclosed subject matter.

FIG. 3 is a simple illustration of a method for providing high availability of servers for uninterrupted services in accordance with some embodiments of the disclosed subject matter.

FIG. 4 is a simple illustration of a method for routing reply or response messages received on server-originated request messages within a server farm in accordance with some embodiments of the disclosed subject matter.

### DETAILED DESCRIPTION

Communication networks and methods for balancing server loads and providing high availability of servers are provided. In some embodiments, a load balancer monitors inbound and outbound traffic in and out of a server farm for balancing advanced server loads. The load balancer has an Internet Protocol (IP) address that can be used as a Virtual IP address (VIP) to represent multiple servers in the server farm. The load balancer distributes communication sessions in accordance with balancing decision rules associated with the server farm. The load balancer can also monitor traffic associated with multiple sessions and respond to a malfunctioning server by identifying the sessions that are assigned to the malfunctioning server and reassign them to another server based on the balancing decision rules.

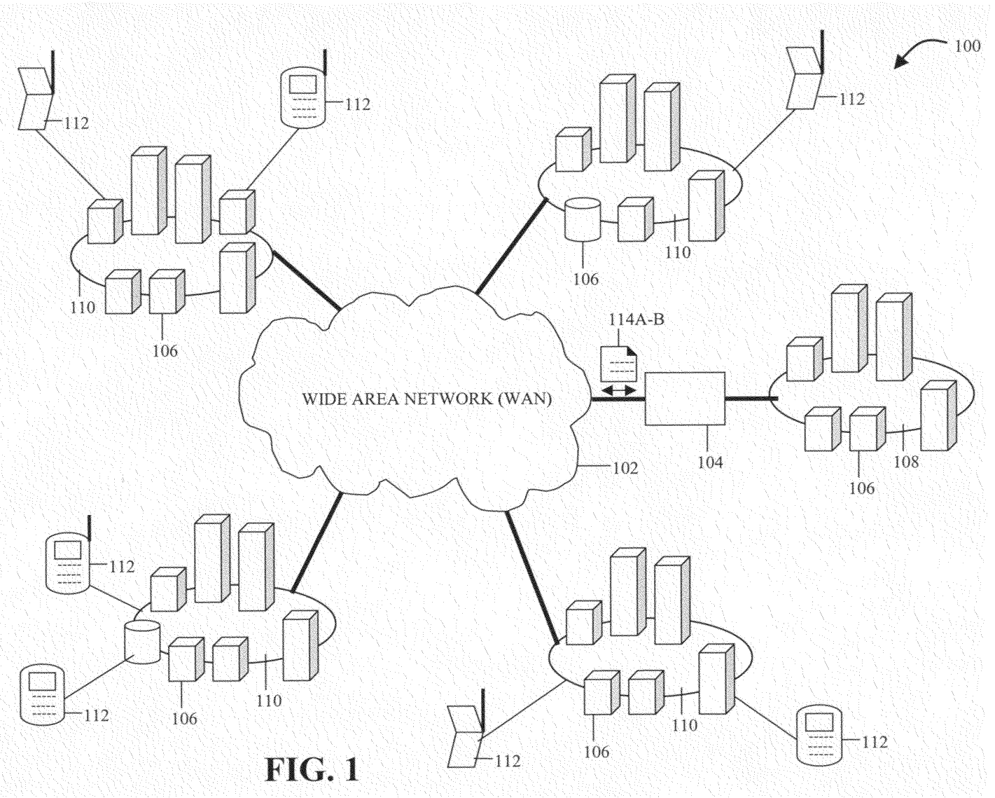

FIG. 1 shows a schematic diagram of a communications network 100 containing elements for balancing server loads and providing high availability of servers in accordance with some embodiments. A Wide Area Network (WAN) 102 connects a plurality of Local Area Networks (LANs) 110 and at least one server farm 108. LANs 110 and server farm 108 comprise a plurality of servers 106. Servers 106 can have a variety of capacities and perform a variety of functions for a plurality of communication devices 112. Server farm 108 is connected to WAN 102 through a load balancer 104. A SIP message 114A, 114B is exchanged among SIP entities through LANs 110 and WAN 102.

WAN 102 can be a various types of computer or communications networks. For instance, it can be the Internet, a wireless network, a cable television network, a telephone network, a powerline network, a satellite network, etc., and can using various suitable protocols, such as TCP/IP, UDP/IP, ATM, and X.25. In some embodiments, WAN 102 can be omitted and a local area network used in its place.

Load balancer 104 can be various suitable mechanisms for balancing server loads. For example, load balancer 104 can be a dedicated load balancer or can be a software application running on a suitable computing device, such as a general purpose computer, a personal computer, a workstation, or various other suitable devices.

Server 106 can be various suitable computing devices capable of receiving a request from a device in communication network 100 and processing it by providing a requested service or by forwarding the request to another location specified therein. Server 106 can be also classified as a SIP server or a non-SIP server. A SIP server can receive and process SIP message 114A, 114B. For instance, it can handle signaling associated with multiple requests or calls providing name resolution and user location.

A SIP server can be a Redirect Server, a Registrar, a Proxy Server, a Back-to-Back (B2B) server, an Event server, and/or various other types of server depending on particular functions that it performs. A SIP Redirect Server helps endpoint clients to find desired addresses by redirecting them to try another server. A SIP Registrar is a server that accepts a register-request for the purpose of updating a location database with the contact information of the user specified in the request.

A SIP Proxy Server is an intermediary entity that acts as both a server and a client for the purpose of making requests on behalf of other clients. Requests are serviced either internally or by passing them on, possibly after translation, to other servers. It can interpret and, if necessary, rewrite SIP request message 114A before forwarding it. A SIP Proxy Server can be further classified into a Stateless Proxy Server and a Stateful Proxy Server. A Stateless SIP Proxy Server forgets all the information associated with a SIP request message 114A once it is processed. A Stateful SIP Proxy Server, on the other hand, saves previous routing information and, therefore, can use the routing information for improving message transfer.

A SIP B2B server receives SIP request messages 114A from one or more clients and establishes connections to one or more parties to which the SIP request messages 114A are directed on behalf of the clients. It can operate in a session mode, in which multiple sessions linked together by sharing a common resource are handled by a same server. Operating in the session mode, it can act as a server for requesting entities and as a client for called entities.

A SIP Event Server can also operate in the session mode. It can receive subscription-requests from one or more subscribing clients and/or publish-requests from a publishing client and send notify-messages to the subscribing clients.

Server farm 108 can be a collection of SIP servers and non-SIP servers, or a collection of SIP servers without any non-SIP servers. It may also include one or more network switches and routers to enable communication among the servers therein. Server farm 108 can be also a collection of processors connected by a fast LAN, such as a Gigabit Ethernet. In some embodiments, server farm 108 includes one or more SIP B2B and Event servers.

LANs 110 can be various suitable networks of computing devices covering a small geographic area. For example, it can be an Ethernet network, a Token Ring network, a wireless network, a cable television network, a telephone network, a satellite network, a powerline network, etc. In some embodiments, LANs 110 can be omitted and servers 106 and devices 112 connected directly to WAN 102.

Communication devices 112 can be any suitable device that can communicate with other entities in communication network 100 by sending and receiving requests and responses, such as mobile phones, portable email devices, Personal Digital Assistant (PDA), IP-phones, computers, video-conferencing end points, set-top boxes, and various other suitable communication devices. Communication devices 112 can act as both SIP User Agent (UA) Client and SIP UA Server. UAs initiate and terminate sessions by exchanging requests and responses. Communication devices 112 can connect to LANs 110 using various suitable technique. For example, devices 112 may be directly connected a LAN by a wire, such as a patch cable, or a wireless signal. As another example, devices 112 may be indirectly connected to a LAN by an intermediate network, such as a telephone network, a cable network, a power-line network, a wireless network, and/or various other suitable networks.

SIP message 114A, 114B can include: a Request 114A and a Response 114B. SIP Request message 114A may include seven different methods: INVITE, ACK, BYE, CANCEL, OPTIONS, REGISTER, and INFO. An INVITE method initiates a call or changes call parameters (re-INVITE). An ACK method confirms a final response for an INVITE method. A BYE method terminates a call. A CANCEL method cancels searches and ringing for a call. An OPTIONS method queries the capabilities of the other side to a call. A REGISTER method registers with a Location Service. An INFO method sends mid-session information that does not modify the session state.

SIP Response message 114B may include: a Provisional Response and a Final Response. It is further divided into six classes of Response Codes 100, 200, 300, 400, 500, and 600. A Provisional Response, which belongs to class 100, is used by servers to indicate progress, but they do not terminate SIP transactions. For example, Response Code 180 indicates to a caller that his call is ringing to inform the callee of a new call. A Final Response, which can belong to classes 200-600, can terminate SIP transactions. For instance, Response Code 200 (OK) indicates to a caller that his request has been received by the intended callee.

A SIP message 114A, 114B is composed of three parts: Start Line, Header, and Body (or Content). Every SIP message 114A, 114B begins with a Start Line, which conveys the message type (e.g., method type in Requests and Response Code in Responses) and a SIP protocol version used. The Start Line can be a Request-line for SIP Request message 114A or a Status-line for SIP Response message 114B. A Request-line includes a Request URI, which indicates the identity of a user or service to which a SIP Request message 114A is addressed. A Status-line holds the numeric Status-code and its associated textual phrase. SIP Header fields are used to convey message attributes and to modify message meaning, and take the format of “<name>:<value>.” The SIP Body is used to describe the session to be initiated, such as audio or video codec types and sampling rates for a multimedia session, or any other suitable textual or binary data of any type which relates in some way to the session. The Start Line and Header convey signaling information whereas the Body conveys the session description information.

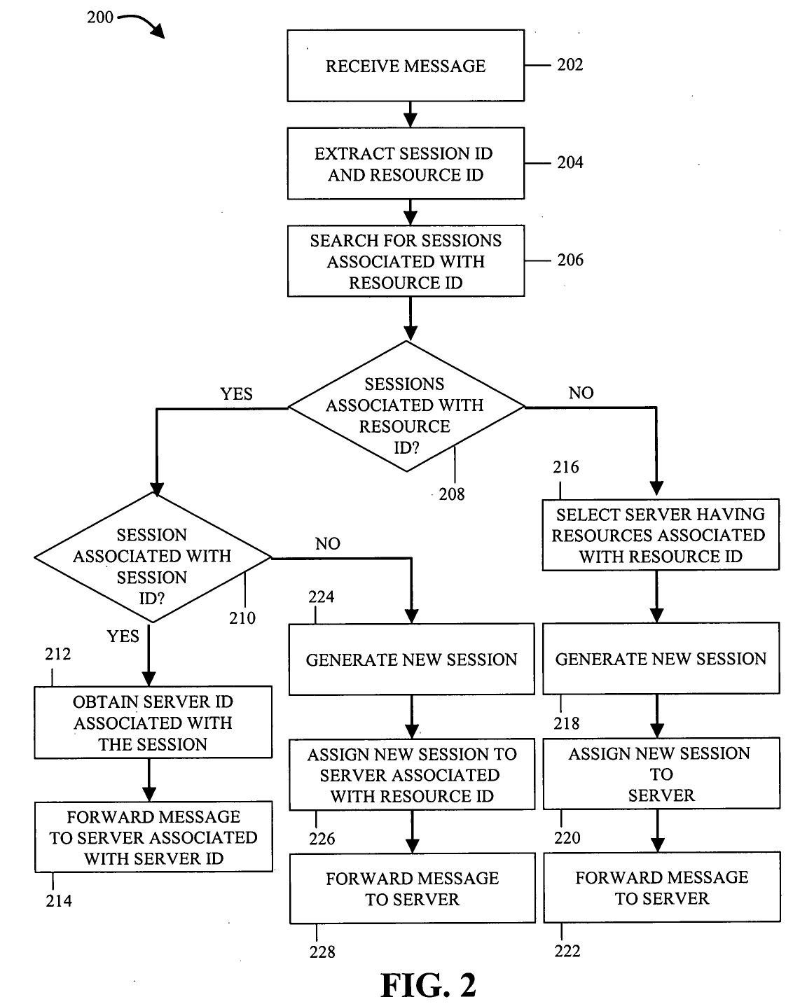

FIG. 2 shows a simple illustration of a method 200 for balancing server loads in accordance with some embodiments. At 202, a message is received. In some embodiments, the message comprises a SIP Request message 114A.

At 204, a session identifier and a resource identifier are extracted from the message by load balancer 104. In some embodiments, the session identifier can be a SIP Call-Id header. A SIP Call-Id header value is a unique value that is identified in a first SIP message, such as SIP message 114A, that causes a session to be generated, and that is used by subsequent SIP messages 114A, 114B during the session. The session identifier is shared by all transactions associated with the session. A transaction can be a set of request(s) and response(s).

In some embodiments, the resource identifier can be a SIP Request URI, which is shared by multiple sessions handled by the same server. A SIP Request URI can be a common resource that enables a server to aggregate and link separate SIP sessions together.

At 206, one or more sessions that are associated with the resource identifier are searched for. In some embodiments, load balancer 104 maintains a session information table that contains active sessions. In such embodiments, when a new message is received, load balancer 104 searches the session information table.

In order to keep session information table up-to-date, method 200 may also delete entries from this table upon a session being terminated. This may be accomplished using various techniques. For example, messages can be monitored to detect indications that a sessions has been completed. Such messages can include BYE methods, SUBSCRIBE/PUBLISH methods where the “Expires” header value is zero, certain SIP Final Response messages, etc. As another example, entries can also be deleted after some given period of inactivity in that session.

At 208, it is determined whether one or more sessions share the same resource identifier. In some embodiments, load balancer 104 compares the resource identifier of the message with the resource identifiers associated with active sessions contained in the session information table.

If no session is found to be associated with the resource identifier at 208, at 216, a server, such as server 106, which has resources associated with the resource identifier of the message, is selected from a server farm, such as server farm 108, in accordance with a set of balancing decision rules. In some embodiments, load balancer 104 can make a balancing decision by hashing the resource identifier, such as a Request URI header value. In some embodiments, a hash function used for hashing the resource identifier can return a server identifier to load balancer 104.

At 218, a new session is generated. In some embodiments, load balancer 104 generates the new session. In some embodiments, load balancer 104 also registers the new session in the session information table using the session identifier and the resource identifier of the message and the selected server identifier. At 220, the new session is assigned to the server that is selected at 216. In some embodiments, load balancer 104 registers the new session, in part, using the server identifier. At 222, the message is forwarded to the server selected at 216. In some embodiments, load balancer 104 forwards the message to the server.

If, however, one or more sessions are determined at 208 to be associated with the resource identifier of the message, it is further determined at 210 whether any of the session(s) is associated with the session identifier of the message. In some embodiments, load balancer 104 makes this determination by comparing the session identifier with the session identifiers of the sessions found to be associated with the resource identifier of the message.

If any of the sessions(s) is found at 210 to be associated with the session identifier of the message, a server identifier associated with the session(s) is obtained at 212. In some embodiments, load balancer 104 obtains the server identifier by locating the session(s) in the session information table and copying the server identifier associated with the session(s). At 214, the message is forwarded to the server associated with the server identifier obtained at 212. In some embodiments, load balancer 104 forwards the message to the server.

If, however, none of the sessions is found at 210 to be associated with the session identifier of the message, a new session is generated at 224. In some embodiments, load balancer 104 generates the new session. At 226, the new session is assigned to the server associated with the session. In some embodiments, load balancer 104 also registers the new session in the session information table using the session identifier and the resource identifier of the message and the server identifier. At 228, the message is forwarded to the server. In some embodiments, load balancer 104 forwards the message to the server.

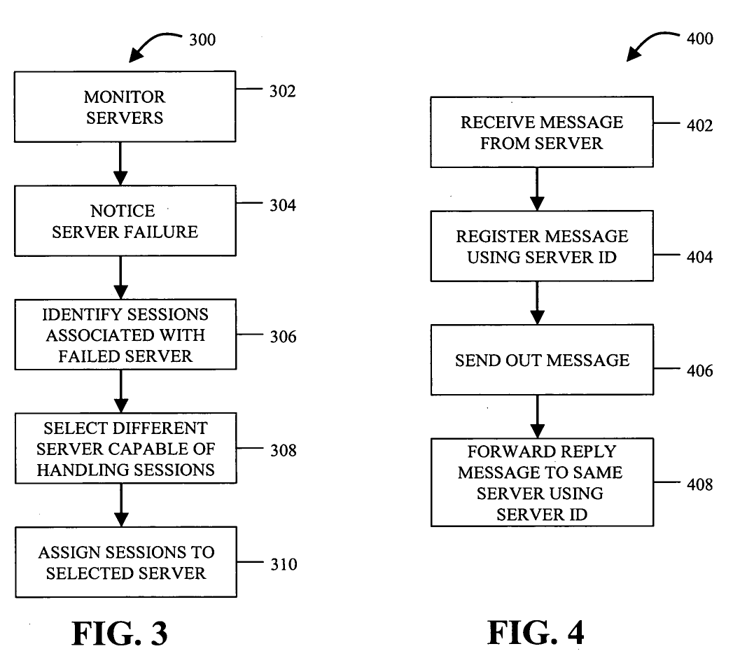

FIG. 3 shows a simple illustration of a method 300 for providing high availability of servers in accordance with some embodiments. At 302, a server is monitored, and, at 304, a failure of that server is noticed. A failure can be any specified event that causes a reduction in the operation of the server, or may be a complete failure. In some embodiments, a load balancer, such as load balancer 104, constantly monitors servers within a server farm, such as server farm 108, to actively respond to server failures. In some embodiments, the load balancer only learns about a server failure when a server does not return a reply or an acknowledgement.

Prior to a failure of the server being monitored, data on the server can be backed-up using any suitable technique. For example, in some embodiments, the data may be mirrored on another server or other servers in the server farm as each transaction occurs. As another example, the data may be copied to another storage device as each transaction occurs. Backing-up the server as each transaction occurs increases the likelihood that as little data as possible from the server will be lost in the event of a failure. Nevertheless, other suitable approaches to backing-up the data may be used as well. For example, the data could be backed-up ever N transactions, every N periods of time, etc.

At 306, sessions associated with the failed server discovered at 304 are identified. In some embodiments, the load balancer queries all sessions associated with the server identifier of the failed server from a session information table stored in the load balancer.

At 308, one or more servers capable of handling those sessions identified at 306 are selected. In some embodiments, the load balancer selects a back-up server from the server farm in accordance with a set of balancing decision rules. Once the back-up server(s) are selected, in some embodiments, data backed-up for the failed server may be made available to the back-up server(s). This may be accomplished by copying the data to the back-up server(s), by providing a link to the data, or using any other suitable technique. For example, if two servers are selected, data for some transactions may be made available to one of these servers and data for other transactions may be made available to the other of these servers. Any suitable number of back-up servers may be used.

At 310, those sessions associated with the failed server are reassigned to the server selected at 308. In some embodiments, load balancer reassigns those sessions to the selected server.

A multiparty teleconference example can be used to further illustrate method 300. Suppose that a server handling a telephone conference. The load balancer may determine that there has been a server failure, as in 302, for instance by monitoring all servers in the server farm. The load balancer then queries its session information table to identify all active sessions that are tied to the failed server, as in 304.

The load balancer discovers that there are four active call sessions that were being handled by the failed server. The load balancer next selects a different server that can handle the conference in accordance with a set of balancing selection rules (that may be specific to the server farm), as in 306. Once a new server is selected, the load balancer reassigns the sessions for each party on the call to the new server, as in 308, by making changes to the entries containing those sessions. Thereafter, messages that are related to those call sessions can be forwarded to the new server.

FIG. 4 shows a simple illustration of a method 400 for routing reply or response messages received on server-originated request messages back to the originating servers within a server farm in accordance with some embodiments. At 402, a message from a server is received. In some embodiments, a load balancer, such as load balancer 104, receives an outbound message originated from a server that belongs to a server farm, such as server farm 108. In some embodiments, the originating server assumes the functionality of a B2B Server and acts as a client by creating new sessions on behalf of other entities.

At 404, the message received at 402 is registered using the originating server identifier. In some embodiments, the load balancer registers the outbound message to a client table. In some embodiments, the load balancer also uses a session identifier and a resource identifier contained in the message received at 402 in addition to the originating server identifier.

At 406, the message is sent out to its destination or its next hop in a communication network, such as communication network 100. In some embodiments, the load balancer has a network address, such as an IP address, and servers in the server farm uses the load balancer IP address as a VIP when sending out messages.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for balancing SIP server load, the method comprising:
receiving a SIP message;
extracting a session identifier and a resource identifier from the message;
searching for one or more sessions that are associated with the resource identifier; and
if there is at least one session that is associated with the resource identifier,
determining whether one of the at least one session is associated with the session identifier; and
if one of the at least one session is determined to be associated with the session identifier,
obtaining a server identifier associated with the one of the at least one session; and
forwarding the message to a server associated with the server identifier.

2. The method of claim 1, further comprising:
if there is no session that is associated with the resource identifier,
selecting a server having resources associated with the resource identifier;
generating a new session;
assigning the new session to the server; and
forwarding the message to the server.

3. The method of claim 2, further comprising registering the new session using the session identifier, the resource identifier, and the server identifier.

4. The method of claim 2, wherein identifying the server comprises hashing the resource identifier.

5. The method of claim 1, further comprising:
if none of the at least one session is determined to be associated with the session identifier,
generating a new session;
assigning the new session to a server associated with the at least one session; and
forwarding the message to the server.

6. The method of claim 5, further comprising registering the new session using the session identifier, the resource identifier, and the server identifier.

7. The method of claim 1, wherein the session identifier comprises a SIP Call-Id header.

8. The method of claim 1, wherein the resource identifier comprises a SIP Request-URI header.

9. The method of claim 1, further comprising:
monitoring the server;
detecting a failure in the server;
identifying sessions that are handled by the server;
selecting a second server having resources for handling the sessions; and
assigning the sessions to the second server.

10. The method of claim 1, further comprising:
receiving an outbound message from one of a plurality of servers;
registering the outbound message using an originating server identifier associated with the one of a plurality of servers and at least one other identifier associated with it; and
sending the outbound message.

11. The method of claim 10, wherein the at least one other identifier comprises one of an outbound session identifier, an outbound resource identifier, and a combination thereof.

12. The method of claim 10, wherein the plurality of servers includes at least one SIP back-to-back user agent.

13. The method of claim 10, wherein the plurality of servers includes at least one event server.

14. The method of claim 10, wherein the outbound message comprises a SIP message.

15. A computer-readable medium containing computer-executable instructions that, when executed by a processor, cause the processor to perform a method for balancing SIP server load, the method comprising:
receiving a SIP message;
extracting a session identifier and a resource identifier from the message;
searching for one or more sessions that are associated with the resource identifier; and
if there is at least one session that is associated with the resource identifier,
determining whether one of the at least one session is associated with the session identifier; and
if one of the at least one session is determined to be associated with the session identifier,
obtaining a server identifier associated with the one of the at least one session; and
forwarding the message to a server associated with the server identifier.

16. The medium of claim 15, where the method further comprises:
if there is no session that is associated with the resource identifier,
selecting a server having resources associated with the resource identifier;
generating a new session;
assigning the new session to the server; and
forwarding the message to the server.

17. The medium of claim 16, where the method further comprises registering the new session using the session identifier, the resource identifier, and the server identifier.

18. The medium of claim 16, wherein identifying the server comprises hashing the resource identifier.

19. The medium of claim 15, where the method further comprises:
if none of the at least one session is determined to be associated with the session identifier,
generating a new session;
assigning the new session to a server associated with the at least one session; and
forwarding the message to the server.

20. The medium of claim 19, where the method further comprises registering the new session using the session identifier, the resource identifier, and the server identifier.

21. The medium of claim 15, wherein the session identifier comprises a SIP Call-Id header.

22. The medium of claim 15, wherein the resource identifier comprises a SIP Request-URI header.

23. The medium of claim 15, where the method further comprises:
monitoring the server;
detecting a failure in the server;
identifying sessions that are handled by the server;
selecting a second server having resources for handling the sessions; and
assigning the sessions to the second server.

24. The medium of claim 15, where the method further comprises:
receiving an outbound message from one of a plurality of servers;
registering the outbound message using an originating server identifier associated with the one of a plurality of servers and at least one other identifier associated with it; and
sending the outbound message.

25. The medium of claim 24, wherein the at least one other identifier comprises one of an outbound session identifier, an outbound resource identifier, and a combination thereof.

26. The medium of claim 24, wherein the plurality of servers includes at least one SIP back-to-back user agent.

27. The medium of claim 24, wherein the plurality of servers includes at least one event server.

28. The medium of claim 24, wherein the outbound message comprises a SIP message.

29. A device for balancing SIP server load comprising:
an interface for receiving a SIP message; and
a processor that:
extracts a session identifier and a resource identifier from the message;
searches for one or more sessions that are associated with the resource identifier; and
if there is at least one session that is associated with the resource identifier,
determines whether one of the at least one session is associated with the session identifier; and
if one of the at least one session is determined to be associated with the session identifier,
obtains a server identifier associated with the one of the at least one session; and
forwards the message to a server associated with the server identifier.

30. The device of claim 29, where the processor also:
if there is no session that is associated with the resource identifier,
selects a server having resources associated with the resource identifier;
generates a new session;
assigns the new session to the server; and
forwards the message to the server.

31. The device of claim 30, wherein the processor also registers the new session using the session identifier, the resource identifier, and the server identifier.

32. The device of claim 30, wherein identifying the server comprises hashing the resource identifier.

33. The device of claim 29, wherein the processor also:
if none of the at least one session is determined to be associated with the session identifier,
generates a new session;
assigns the new session to a server associated with the at least one session; and
forwards the message to the server.

34. The device of claim 33, wherein the processor also registers the new session using the session identifier, the resource identifier, and the server identifier.

35. The device of claim 29, wherein the session identifier comprises a SIP Call-Id header.

36. The device of claim 29, wherein the resource identifier comprises a SIP Request-URI header.

37. The device of claim 29, wherein the processor also:
monitors the server;
detects a failure in the server;
identifies sessions that are handled by the server;
selects a second server having resources for handling the sessions; and
assigns the sessions to the second server.

38. The device of claim 29, wherein the interface also receiving an outbound message from one of a plurality of servers and the processor also:
registers the outbound message using an originating server identifier associated with the one of a plurality of servers and at least one other identifier associated with it; and
sends the outbound message.

39. The device of claim 38, wherein the at least one other identifier comprises one of an outbound session identifier, an outbound resource identifier, and a combination thereof.

40. The device of claim 38, wherein the plurality of servers includes at least one SIP back-to-back user agent.

41. The device of claim 38, wherein the plurality of servers includes at least one event server.

42. The device of claim 38, wherein the outbound message comprises a SIP message.
